(19) United States
(12) Patent Application Publication
(10) Pub. No.: US 2005/0142272 A1
(43) Pub. Date: Jun. 30, 2005

(54) Low-gluten wafer and method of making same

(75) Inventors: Jane Frances Heschmeyer, Clyde, MO (US); Lynn Marie D'Souza, Clyde, MO (US); Kathleen Ann Becker, Clyde, MO (US)

Correspondence Address: KELLEY DRYE & WARREN LLP, 101 PARK AVENUE, NEW YORK, NY, 10178, US

(73) Assignee: Benedictine Convent of Perpetual Adoration, Clyde, MO (US)

(21) Appl. No.: 10/748,287

(22) Filed: Dec. 31, 2003

(51) Int. Cl. A21D 10/00

(52) U.S. Cl. 426/549

(57) ABSTRACT

A low-gluten communion wafer suitable for ingestion by gluten intolerant persons while complying with the requirements of the Eucharist as proscribed by the Roman Catholic Church. The wafer includes wheat starch, a pre-gelatinized wheat starch and water properly mixed and cooked to form wafers suitable for reception during Holy Communion.

### BACKGROUND OF THE INVENTION

The present invention relates generally to low-gluten bread products, and more specifically low-gluten communion wafers, or altar breads.

The Roman Catholic Church provides millions of bread communion wafers to its congregation annually during reception of Holy Communion. In the Roman Rite, the bread prepared for the Eucharist must be unleavened. According to section 2 of Canon 924, Article 3 of the Code of Canon Law, 1983, from Book IV, Sanctifying Function of The Church, Part I, Sacraments, Title III, The Most Holy Eucharist, Chapter 1 of the Eucharistic Celebration,, “[t]he bread must be made of wheat alone and recently made so that there is no danger of corruption.” Furthermore, in a 1929 Instruction, the Sacred Congregation for the Discipline of the Sacraments taught that bread made of any substance other than wheat is invalid matter, as is bread to which has been added such a great quantity of another substance that it can no longer be considered wheat bread in the common estimation.

As such, in order for the wafers to be valid matter for the Eucharist, the bread must be made solely of wheat, contain enough gluten to effect the confection of the bread, be uncorrupted by foreign materials and unaffected by any preparation or baking methods which would alter its nature. Although the church has not stipulated the amount of gluten necessary for validity in such bread by minimum percentage or weight, hosts which do not contain gluten are considered invalid for Mass.

Typically communion wafers are composed of wheat protein that includes large amounts of gluten. In recent years, pastors across the United States have received numerous inquiries from those afflicted with various manifestations of gluten intolerance, such as Celiac Sprue disease. Many gluten intolerant sufferers are unable to ingest wheat flour having a large amount of gluten commonly used in preparation of communion wafers in the United States. Those who suffer from gluten intolerance, especially those afflicted with Celiac Sprue disease, each react differently to varying amounts of gluten contained in wheat bread and other products. Medical opinion on the best treatment for this disease varies greatly from moderate intake of gluten to a gluten free diet.

As such, the common practice for gluten-intolerant persons was to receive only the Precious Blood (i.e. consecrated wine) at Holy Communion. However, it has been found that the Precious Blood can be “contaminated” with gluten at the co-mingling rite and extra care must be taken to avoid contact between the communion wafers and the Precious Blood.

Notwithstanding the above requirements, another challenge is to create a communion wafer that is minimally palatable. There have been attempts to create palatable low-gluten breads however those products are typically made with potato flour, rice flour or corn and these ingredients are not considered viable by the Roman Catholic Church. Others have tried to supplant wheat containing gluten with Spelt, a wheat (Triticum aestivum spelta) with lax spikes and spikelets containing two light red kernels. However it has been found that gluten-intolerant persons react negatively to Spelt laden breads. Still others have tried various ingredients and formulae of wheat and pre-gelatinized wheat yet the resulting products have been consistently found considerably less than palatable.

As such, there exists a need for a palatable low-gluten communion wafer, and a method for making the low-gluten communion wafer, suitable for ingestion by gluten-intolerant persons while complying with the validity requirements for the Eucharist.

### SUMMARY OF THE INVENTION

The present invention includes a low-gluten wafer, and a method for making a low-gluten communion wafer, suitable for ingestion by gluten-intolerant persons while satisfying the validity requirements for the Eucharist according to Canon 924.2 (incorporated herein by reference).

In a first embodiment, the present invention includes a low gluten wafer including about 1.0 part wheat starch, about 1.0 part pre-gelatinized wheat starch, where the wheat starch and pre-gelatinized wheat starch are combined into a substantially homogeneous mixture. The low gluten wafer also includes about 2.0 parts of water having a temperature between about room temperature to about 212 degrees Fahrenheit, where the water is combined with substantially homogeneous mixture of wheat starch and pre-gelatinized wheat starch until the entire mixture is substantially homogeneous to create a pre-cooked mixture.

The low gluten wafer is prepared by heating an amount of the pre-cooked mixture of between about 1/20^{th} of a teaspoon to about ½ of a teaspoon of the temperature between about 250 degrees Fahrenheit to about 400 degrees Fahrenheit for between about 5 minutes to about 10 minutes.

Alternative embodiments may include cooling the baked wafers to room temperature and storing them in an airtight environment. Further embodiments may include cooling the baked wafers to temperatures below 32 degrees Fahrenheit to prolong shelf life.

In a second embodiment, the present invention includes a method of making a low-gluten wafer including the steps of combing wheat starch with pre-gelatinized wheat starch into a first substantially homogeneous mixture, adding water to the first homogenous mixture where the water has a temperature between about room temperature and about 212 degrees Fahrenheit degrees until the combination of water and the first substantially homogeneous mixture create a second substantially homogeneous mixture, sheeting about between 1/20^{th} of a teaspoon to about ½ of a teaspoon of the second homogeneous mixture onto a cooking surface having a temperature between about 100 degrees Fahrenheit and about 450 degrees Fahrenheit. In some embodiments, the cooking surface may include two parallel heated plates where the second homogeneous is sheeted between the parallel plates. In some embodiments the sheeting step includes shaping the second homogeneous mixture in wafers into circles having a diameter of about 1.0 inch and about 3.5 inches.

In a third embodiment, the present invention includes a low gluten wafer having a pre-cooked mixture composition of about 25% by weight wheat starch, about 25% by weight pre-gelatinized wheat starch, and about 50% water, where the water has a temperature between about room temperature to about 212 degrees Fahrenheit. In creating the pre-cooked mixture, the wheat starch and pre-gelatinized wheat starch are first combined into a substantially homogeneous mixture and the water is then added and mixed until the entire mixture is substantially homogeneous. The entire pre-cooked mixture is sheeted between two parallel heating plates in wafers having quantities of about 1/20^{th} of a teaspoon to about ½ of a teaspoon in shaped circles having a diameter between about 1.0 inch and 3.5 inches and cooked for between about 5 minutes and about 10 minutes at a temperature of about 350 degrees Fahrenheit. In some embodiments sheets of between about 16 and about 20 wafers are cooked simultaneously.

In some embodiments, the precooked mixture can include about 2 tablespoons of pre-gelatinized wheat starch, about 2 tablespoons of pre-gelatinized wheat starch and about ¼ cup of water.

### DETAILED DESCRIPTION OF THE INVENTION

The low-gluten wafer of the present invention may be prepared manually or automatically with conventional mixing and baking systems. Preferably the wafer is cooked between two hot plates at a temperature of between about 275 degrees Fahrenheit and 400 degrees Fahrenheit for between about 5 minutes and about 10 minutes. There are some embodiments where the wafer is cooked at different temperatures for periods longer and shorter than those taught in this description primarily corresponding to the environment within which the wafer is prepared. For example, in dry climates it will be understood by those skilled in the art that the wafer may be cooked for substantially less than 5 minutes. Alternatively, in humid climates it will be understood that the wafer may be cooked for substantially more than 10 minutes. Additionally, there are embodiments where the wafer may be cooked on a conventional griddle, or even a conventional baking sheet in a conventional baking oven.

The pre-cooked mixture may start with about 1.0 part wheat starch and about 1.0 part pre-gelatinized wheat starch. Other amounts have been found to be satisfactory however the ratio of 1 part wheat and 1 part pre-gelatinized wheat starch is preferable. The wheat starch and pre-gelatinized wheat starch can be combined in any conventional manner into a substantially homogeneous mixture. The pre-cooked mixture may also include about 2.0 parts of water having a temperature between about room temperature to about 212 degrees Fahrenheit, where the water is combined with the substantially homogeneous mixture of wheat starch and pre-gelatinized wheat starch until the entire pre-cooked mixture is substantially homogeneous. Again mixing of the entire pre-cooked mixture may be accomplished manually or any conventional automatic process. It will be understood that room temperature may be considered between about 68 degrees Fahrenheit and about 72 degrees Fahrenheit.

The low gluten wafer may be prepared by heating an amount of the pre-cooked mixture of between about 1/20^{th} of a teaspoon to about ½ of a teaspoon at a temperature between about 250 degrees Fahrenheit to about 400 degrees Fahrenheit for between about 5 minutes to about 10 minutes. It will be understood that while the preferred embodiment is disclosed herein, the low-gluten wafer of the present invention may be accomplished by preparing amounts smaller than 1/20^{th} of a teaspoon and larger than ½ of a teaspoon. Furthermore the cooking temperature may vary as well as the cooking time depending upon the environment and the desired resulting condition of the wafer.

In some embodiments may include cooling the baked wafers to room temperature and storing them in an airtight environment. Further embodiments may include cooling the baked wafers to temperatures below 32 degrees Fahrenheit to prolong shelf life.

Also disclosed is method of making a low-gluten wafer including the steps of combing wheat starch with pre-gelatinized wheat starch into a first substantially homogeneous mixture, adding water to the first homogenous mixture where the water has a temperature between about room temperature and about 212 degrees Fahrenheit degrees until the combination of water and the first substantially homogeneous mixture create a second substantially homogeneous pre-cooked mixture, sheeting between about 1/20^{th} of a teaspoon to about ½ of a teaspoon of the pre-cooked mixture onto a cooking surface having a temperature between about 100 degrees Fahrenheit and about 450 degrees Fahrenheit.

In some embodiments, the cooking surface may include two parallel heated plates where the pre-cooked mixture is sheeted between the parallel plates. In some embodiments the sheeting step includes shaping the second homogeneous mixture in wafers into circles having a diameter of about 1.0 inch and about 3.5 inches.

In still another embodiment a low gluten wafer may have a pre-cooked mixture composition of about 25% by weight wheat starch, about 25% by weight pre-gelatinized wheat starch, and about 50% water, where the water has a temperature between about room temperature to about 212 degrees Fahrenheit. In creating the pre-cooked mixture, the wheat starch and pre-gelatinized wheat starch are first combined into a substantially homogeneous mixture and the water is then added and mixed until the entire mixture is substantially homogeneous. The entire pre-cooked mixture is sheeted between two parallel heating plates in wafers having quantities of about 1/20^{th} of a teaspoon to about ½ of a teaspoon in shaped circles having a diameter between about 1.0 inch and 3.5 inches and cooked for between about 5 minutes and about 10 minutes at a temperature of about 350 degrees Fahrenheit. In some embodiments sheets of between 16 and 20 wafers are cooked simultaneously.

In some embodiments it may be necessary to have a larger resulting wafer. For example, the Presider at the celebration of the Eucharist typically uses a larger wafer of up to about 3.5 inches in diameter. This allows the congregation to easily view the wafer when the Presider raises the wafer in celebration of the Eucharist at the pulpit. During the liturgy, before Communion, this larger wafer is broken into pieces according to the fraction rite. Of course, the larger resulting wafer will require a larger amount of pre-cooked mixture hence the upper range of up to about ½ of a teaspoon. It is entirely conceivable that there may be wafers made In some embodiments, the precooked mixture can include about 2 tablespoons of pre-gelatinized wheat starch, about 2 tablespoons of pre-gelatinized wheat starch and about ¼ cup of water. The combination and cooking of the ingredients described herein results in a palatable communion wafer that complies with the Eucharist requirements for reception of Holy Communion.

An example of a suitable pre-gelatinized wheat starch is known as Gemgel 100 prepared by Manildra Milling Corporation. Gemgel 100 is food grade, pre-gelatinized wheat starch having the chemical properties listed in Table 1 and the typical physical properties listed in Table 1.

TABLE 1

| | |
|---|---|
| Moisture | 9.0% |
| Protein (N × 5.7) | 0.40% |
| Ash | 0.40% |
| Fat | 0.50% |
| Fiber | 0.50% |
| pH | 6.0 |

TABLE 2

| | |
|---|---|
| Color: | White |
| Bulk Density: | 30-35 lb/cu.ft. |
| % thru U.S. #100: | 50% minimum |

An example of a suitable wheat starch is known as Gemgel 100+ also prepared by Manildra Milling Corporation. Gemgel 100+ is highly refined food grade suitable for applications requiring superior color, flavor and clarity in a basic unmodified starch. Gemgel 100+ is typically used to provide thickening properties for a variety of food application and has the chemical properties listed in Table 3 and the typical physical properties listed in Table 4.

TABLE 3

| | |
|---|---|
| Moisture | 11.0% |
| Protein (N × 5.7) | 0.30% |
| Ash | 0.25% |
| Fat | 0.50% |
| Fiber | 0.50% |
| pH | 6.50 |

TABLE 4

| Color: | White |
|---|---|
| Bulk Density: | 38-40 lb/cu.ft. |
| % thru U.S. #40: | 100.0% |
| % thru U.S. #60: | 100.0% |
| % thru U.S. #100: | >95.0% |
| % thru U.S. #325: | >60.0% |

Another example of a suitable wheat starch is known as Aytex P wheat starch manufactured by ADM Food Additives. Aytex P wheat starch has the nutritional information as listed below in Table 4.

TABLE 5

| | Nutrient Quantity/ | |
|---|---|---|
| Nutrient | 100 grams of Ingredient | |
| Total Calories | 370 | Kcal |
| Calories from Fat | 0.8 | Kcal |
| Calories from Saturated Fat | 0 | Kcal |
| Moisture | 11.0 | g |
| Ash | 0.2 | g |
| Total Fat | 0.1 | g |
| Saturated Fat | 0 | g |
| Polysaturated Fat | 0 | g |
| Monounsaturated Fat | 0 | g |
| Cholesterol | 0 | g |
| Sodium | 89 | g |
| Potassium | 17 | mg |
| Total Carbohydrate | 92 | g |
| Dietary Fiber | 0.2 | g |
| Soluble Fiber | 0 | g |
| Insoluble Fiber | 0.2 | g |
| Sugars | 0 | g |
| Sugar Alcohol | 0 | g |
| Other Carbohydrates | 89.2 | g |
| Protein | 0.3 | g |
| Vitamin A | <200 | IU |
| Vitamin C | 0 | mg |
| Calcium | 18 | mg |
| Iron | 2 | mg |

The combination and cooking of the ingredients described herein results in a palatable communion wafer that complies with the Eucharist requirements for reception of Holy Communion.

It will be apparent to one of skill in the art that described herein is a novel low-gluten wafer and method for making a low-gluten wafer. While the invention has been described with reference to specific preferred embodiments, it is not limited to these embodiments. The invention may be modified or varied in many ways and such modifications and variations as would be obvious to one of skill in the art are within the scope and spirit of the invention and are included within the scope of the following claims.

1. A low-gluten wafer comprising:
about one part wheat starch, about one part pre-gelatinized wheat starch, where the wheat starch and the pre-gelatinized wheat starch are combined to form a first substantially homogeneous mixture, and
about two parts water, where the water has a temperature of between about 100 degrees Fahrenheit and about 150 degrees Fahrenheit, said water added to said first substantially homogeneous mixture to create a substantially homogenous pre-cooked mixture, where between about 1/20^{th} of a teaspoon to about ½ of the pre-cooked mixture is heated in a cooking environment having a temperature between about 250 degrees Fahrenheit to about 400 degrees Fahrenheit for between about 5 minutes to about 10 minutes.

2. The low-gluten wafer according to claim 1 wherein, the wafers, after heating, are cooled to about room temperature.

3. The low-gluten wafer according to claim 2 wherein the wafers are stored in an airtight environment.

4. The low-gluten wafer according to claim 1 wherein the wafers, after heating, are cooled to temperatures below about 32 degrees Fahrenheit

5. The low-gluten wafer according to claim 1, where the water has a temperature of about 125 degrees Fahrenheit

6. A method of making a low-gluten wafer comprising the steps of:
combining about one part wheat starch with about one part pre-gelatinized wheat starch into a first substantially homogeneous mixture,
adding water to the first homogenous mixture where the water has a temperature between about room temperature and about 212 degrees Fahrenheit degrees until the combination of water and the first substantially homogeneous mixture create a substantially homogeneous pre-cooked mixture,
sheeting portions of the pre-cooked mixtures of about between 1/20^{th} of a teaspoon to about ½ of a teaspoon onto a cooking surface having a temperature between about 250 degrees Fahrenheit and about 350 degrees Fahrenheit, and
cooking said portions for about 5 minutes to 10 minutes.

7. The method according to claim 6, where the sheeting step further includes shaping the portions of the pre-cooked homogeneous mixture into wafers having a diameter of about 1.0 inch to about 3.5 inches.

8. The method according to claim 7, where the cooking surface may include two parallel heated plates where said portion of the pre-cooked homogeneous is sheeted between the parallel plates.

9. The method according to claim 7, further comprising the step of cooling the wafers to a temperature between about 32 degrees Fahrenheit to room temperature.

10. The method according to claim 7, further comprising the step of cooling the wafers to a temperature below about 32 degrees Fahrenheit.

11. A low gluten wafer having a pre-cooked mixture composition of about 25% by weight wheat starch, about 25% by weight pre-gelatinized wheat starch, and about 50% water, where said water has a temperature between about room temperature to about 212 degrees Fahrenheit, where the wheat starch and pre-gelatinized wheat starch are first combined into a substantially homogeneous mixture and the water is then added and mixed to create a substantially homogeneous precooked mixture.

12. The low gluten wafer according to claim 11 where the water has a temperature of about 125 degrees Fahrenheit.

13. A low-gluten wafer comprising:
about 2 tablespoons of pre-gelatinized wheat starch,
about 2 tablespoons of pre-gelatinized wheat starch, and
about ¼ cup of water.
